(19) United States
(12) Patent Application Publication
(10) Pub. No.: US 2022/0382660 A1
(43) Pub. Date: Dec. 1, 2022

(54) METHOD AND COMPUTING DEVICE FOR GENERATING ACTION HISTORY DATA OF APPLICATION AND COMPUTER-READABLE NON-TRANSITORY RECORDING MEDIUM

(71) Applicant: SAMSUNG SDS CO., LTD., Seoul (KR)

(72) Inventors: Tae Hwang YOO, Seoul (KR); Bin Na LEE, Seoul (KR); Da Yeon KIM, Seoul (KR); Ji Won OK, Seoul (KR)

(21) Appl. No.: 17/826,647

(22) Filed: May 27, 2022

(30) Foreign Application Priority Data
May 28, 2021 (KR) 10-2021-0069286

(51) Int. Cl. G06F 11/30; G06F 11/07

(52) U.S. Cl. CPC G06F 11/3075; G06F 11/0775; G06F 11/0787; G06F 2201/80

(57) ABSTRACT

A method of generating action history data of an application according to an embodiment of the present disclosure is performed by a computing device. The method includes acquiring a first log generated by an application, acquiring a second log generated by a database (DB), matching application log entries included in the first log to DB log entries included in the second log, and generating action history data about actions performed by the application on the basis of a result of the matching.

### CROSS-REFERENCE TO RELATED APPLICATION AND CLAIM OF PRIORITY

This application claims the benefit under 35 USC § 119 of Korean Patent Application No. 10-2021-0069286 filed on May 28, 2021, in the Korean Intellectual Property Office, the entire disclosure of which is incorporated herein by reference for all purposes.

### BACKGROUND

### 1. Field of the Disclosure

The present disclosure relates to a method and a device for generating action history data of an application, and more particularly, to a method of generating and managing data which represents history of actions or events performed by an application in a system at least including the application and a database (DB) and a device for implementing the method.

### 2. Description of the Related Art

Services provided by a computing device are often provided by an application and a database (DB) which interoperates with the application. In particular, a system which is built in a client-server environment or a cloud environment to provide a service to many unspecified users may additionally include a web application server (WAS) and a DB server in many cases.

In such a system, there is a need to appropriately record history data about actions or events performed by an application. For example, it has been necessary to appropriately record the content of an action, which is requested by a user who accesses the WAS and performed by the WAS, and changes in information stored in the DB before and after the action is performed and to conduct ex-post analysis on the basis of the records for various purposes from various points of view. Also, various technical methods have been devised to achieve this.

First, a method is taken into consideration in which the application generates and stores a log with regard to an action performed by the application and changes in the DB resulting from the action. To this end, however, it is necessary to implement additional logic in the application to record values before and after a data change made by a user request.

As an example, a temporary table having the same schema as a meta table of the DB may be generated for the purpose of checking changes, and data may be recorded in the temporary table before the data is changed by a user request. After the data is changed by the user request, the data of the temporary table may be compared with data of the meta table such that data changes made by the user request may be detected and recorded.

As another example, an additional column for storing previous data may be provided for every column in the meta table of the DB, and data changes made by a user request may be detected and recorded using values of such previous data columns before and after data is changed by the user request.

Apart from an action requested by a user, both methods involve a DB update and inquiry transaction for generating user request processing history data. Accordingly, response speed to an action requested by a user may be slow, and the overall system may suffer from an additional processing load and consume additional storage space. Also, the application inquires about and uses values recorded in the DB before and after a user request is processed. Accordingly, when data is rolled back for a reason such as an error occurring during the transaction of changing data stored in the DB, or identical DB entries are changed at the same time by several applications or several processes, the application may acquire inconsistent data and generate the history of incorrect data changes.

Meanwhile, a method of using the change log of the DB may be taken into consideration with regard to an action performed by the application and changes in the DB resulting from the action. Some DB management systems (DBMSs) record data changes in a log file, which is referred to as a “binary log” or “binlog.” The DB change log file is recorded for the purpose of being mainly used in synchronization, dualization, and/or data recovery between DBs. The DB change log file includes column-specific post-change and pre-change values of each row of the DB which is committed normally, a table name, a transaction identifier (ID), query (insert, delete, update, etc.) information, etc.

However, there are limitations in generating history data about an action or event performed by the application using a DB change log.

First, in a DB change log, a value is generated for each row of a table before and after a change. In practice, one user request or action processed by the application frequently changes one or more rows of one or more tables at the same time. Accordingly, it is difficult to analyze a user's request or action with only one row present in a DB change log, and a user's request or action may be appropriately analyzed only after two or more rows are comprehensively analyzed.

Second, user session information or server request information that causes a change in the DB is information that is frequently usefully referenced in analyzing the action history of the application. Here, a DB change log only includes information on data changes and does not include user session information or server request information that causes the changes. Accordingly, it is additionally necessary to record user session information or server request information in a separate table and cross-refer or map the user session information or server request information to the DB change log. In this process, the overall system may suffer from an additional processing load and consume additional storage space.

Third, since a DB change log is mainly used for synchronization, dualization, and/or data recovery between DBs, when a DB change log which has already been processed once for such a purpose is processed again, overlapping history data about an action or event performed by the application may be generated.

Accordingly, a new method is required for solving all the problems of the application-driven method of recording history data of actions or events performed by an application and the method of recording history data of actions or events performed by an application on the basis of a DB change log.

### SUMMARY

Aspects of the present disclosure provide a method and device for generating action history data of an application.

Aspects of the present disclosure also provide a method of generating and managing data that represents the history of an action or event performed by an application in a system including the application and a database (DB) and a device for implementing the method.

Aspects of the present disclosure also provide a method and device for recording content of an action performed by a web application server (WAS) in combination with a change in information stored in a DB before and after the action is performed.

Aspects of the present disclosure also provide a method and device for accurately analyzing an action of a user of an application by considering history generated by the application and history generated by a DB together.

Aspects of the present disclosure also provide a method and device for generating action history data of an application without a response time delay of the application to a user request.

Aspects of the present disclosure also provide a method and device for minimizing a processing load and storage space consumption of a whole system even while generating action history data of an application.

It should be noted that objects of the present disclosure are not limited to the above-described objects, and other objects of the present disclosure will be apparent to those skilled in the art from the following descriptions.

According to an aspect of the inventive concept, there is provided a method of generating action history data of an application performed by a computing device. The method includes acquiring a first log generated by an application, acquiring a second log generated by a database (DB), matching application log entries included in the first log to DB log entries included in the second log, and generating action history data about actions performed by the application on the basis of a result of the matching.

The acquiring of the first log may include storing application log entries including information on the actions performed by the application in a first queue, and extracting at least one log entry from the first queue.

The application log entries may include information on a user who has requested the actions performed by the application.

The application log entries may include transaction identifiers (IDs) of transactions committed on the DB by the actions performed by the application.

The acquiring of the second log may include recording, in a DB log file, log entries including information on changes made in the DB by the actions performed by the application, storing the log entries included in the DB log file in a second queue, and extracting at least one log entry from the queue.

Each of the application log entries and the DB log entries may include a transaction identifier (ID) field, and the matching of the application log entries to the DB log entries may include identifying an application log entry and a DB log entry having the same value in the transaction ID fields.

The matching of the application log entries to the DB log entries may further include grouping log entries having the same transaction ID among a plurality of DB log entries included in the second log.

The generating of the action history data may include combining information included in the matched log entries.

The generating of the action history data may further include storing the action history data in the DB.

The generating of the action history data may further include automatically determining types of the actions on the basis of the combined information.

The generating of the action history data may further include storing unidentified action history data whose action types are not determined in a third queue.

The method may further include processing unidentified action history data.

The processing of the unidentified action history data may include determining a number of the pieces of unidentified action history data, and generating a notification on the basis of a determination that the number is a threshold value or more.

The processing of the unidentified action history data may include grouping the plurality of pieces of unidentified action history data, and providing a report including a result of the grouping.

The grouping of the plurality of pieces of unidentified action history data may include grouping the plurality of pieces of unidentified action history data on the basis of at least one of user information, time information, and target DB table information corresponding to the unidentified action history data.

The processing of the unidentified action history data may include receiving classification information corresponding to the unidentified action history data, and the generating of the action history data may include determining types of the actions and generating the action history data on the basis of the received classification information.

According to an aspect of the inventive concept, there is provided a computing device for generating action history data of an application. The computing device includes a log processor configured to process a first log generated by an application and a second log generated by a database (DB), and an action history analyzer configured to match application log entries included in the first log to DB log entries included in the second log and generate action history data about actions executed by the application on the basis of a result of the matching.

Each of the application log entries and the DB log entries may include a transaction identifier (ID) field, and the action history analyzer identifies an application log entry and a DB log entry having the same value in the transaction ID fields.

The action history analyzer may combine information included in the matched log entries.

According to an aspect of the inventive concept, there is provided a computer-readable non-transitory recording medium including instructions, wherein, when the instructions are executed by a processor, the instructions cause the processor to perform operations of: acquiring a first log generated by an application, acquiring a second log generated by a database (DB), matching application log entries included in the first log to DB log entries included in the second log, and generating action history data about actions performed by the application on the basis of a result of the matching.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a diagram showing an exemplary server system for providing a web application service (WAS) to which a method and device according to an exemplary embodiment of the present disclosure may be applied;

FIG. 2 is a diagram illustrating a configuration and operation of an action analyzer of the server system illustrated with reference to FIG. 1;

FIG. 3 is a diagram showing an exemplary application log that may be referenced to understand some exemplary embodiments of the present disclosure;

FIG. 4 is a diagram showing an exemplary database (DB) log that may be referenced to understand some exemplary embodiments of the present disclosure;

FIG. 5 is a diagram showing an example of an application log and a DB log that are matched to each other and may be referenced to understand some exemplary embodiments of the present disclosure;

FIG. 6 is a table showing exemplary application action history data generated according to some exemplary embodiments of the present disclosure;

FIG. 7 is a flowchart illustrating a method of generating action history data of an application according to another exemplary embodiment of the present disclosure;

FIG. 8 is a flowchart illustrating some operations of the method described with reference to FIG. 7 in further detail;

FIG. 9 is a flowchart illustrating some operations of the method described with reference to FIG. 7 in further detail;

FIG. 10 is a flowchart illustrating some operations of the method described with reference to FIG. 7 in further detail; and

FIG. 11 is a diagram showing a hardware configuration of a terminal device according to some exemplary embodiments of the present disclosure.

### DETAILED DESCRIPTION OF THE EMBODIMENTS

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present invention, when it is determined that the detailed description of the related well-known configuration or function may obscure the gist of the present invention, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the invention. In this specification, the singular also includes the plural unless specifically stated otherwise in the phrase.

In addition, in describing the component of this invention, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, some embodiments of the present invention will be described in detail with reference to the accompanying drawings.

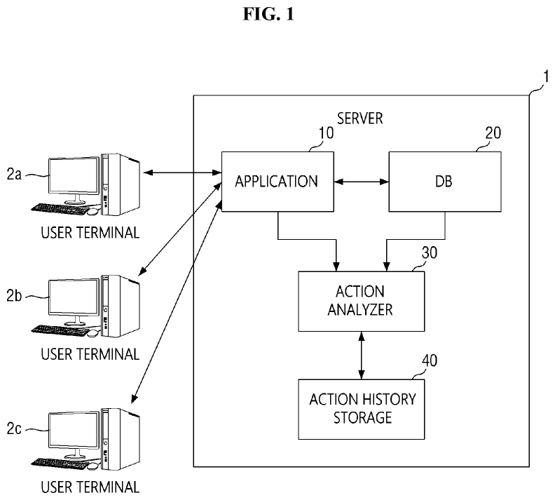

FIG. 1 is a diagram showing an exemplary server system 1 for providing a web application service (WAS) to which a method and device according to an exemplary embodiment of the present disclosure may be applied.

The server system 1 according to the present embodiment may provide the WAS to user terminals 2a, 2b, and 2c. The server system 1 may include an application provider 10, a database (DB) provider 20, an action analyzer 30, and an action history storage 40.

The application provider 10 may be, for example, a server that provides an arbitrary WAS, such as a search, a community, social media, e-commerce, etc., to the user terminals 2a, 2b, and 2c. For the purpose of providing such a WAS, the application provider 10 may process various actions requested by the user terminals 2a, 2b, and 2c. The application provider 10 may identify and record parameters that are involved in requests from the user terminals 2a, 2b, and 2c and specify details of various requested actions. The application provider 10 may inquire of the DB provider 20 about data required for processing the requests from the user terminals 2a, 2b, and 2c and update a DB by transmitting data, which is newly generated or changed in the process of performing actions for processing the requests of the user terminals 2a, 2b, and 2c, to the DB provider 20. As an application log, the application provider 10 may record parameters, which specify the actions requested from user terminals 2a, 2b, and 2c and details of the actions, and identifiers (IDs) of DB transactions executed in the process of performing the actions.

The DB provider 20 may be a server for providing a relational database (RDB), such as MySQL, MSSQL, MariaDB, etc. The DB provider 20 may receive a query for data inquiry, generation, update, deletion, etc. from the application provider 10, execute the query on the stored DB, and return the result to the application provider 10. Also, the DB provider 20 may return a transaction ID corresponding to the query received from the application provider 10 to the application provider 10. The DB provider 20 may record changes in the DB in a change log which is referred to as, for example, a “binary log” or “binlog.” A change log file may include information on data generation, update, deletion, etc. made on DBs and information on an ID of a transaction which causes the change for use in synchronization, dualization, and/or data recovery between DBs. Such a DB change log or change log file is referred to as a “DB log” herein.

The action analyzer 30 may generate action history data about actions executed by an application on the basis of log entries included in the application log and log entries included in the DB log.

Specifically, the action analyzer 30 may acquire the application log generated by the application provider 10 and the DB log generated by the DB provider 20.

Also, the action analyzer 30 may match log entries included in the application log and log entries included in the DB log to each other. Here, the action analyzer 30 may match relational log entries to each other using transaction IDs each included in the application log entries and the DB log entries. Specifically, transaction IDs of transactions, which are committed on the DB provider 20 by the application provider 10 in the process of processing a certain request from a user terminal, are included in both the application log entries and the DB log entries. The action analyzer 30 may identify application log entries and DB log entries related to each other using transaction IDs each included in the application log entries and the DB log entries.

The action analyzer 30 may combine information of an application log entry and a DB log entry matched to each other and automatically determine a type of action on the basis of the combined information. At this time, various action patterns which are registered in advance by an administrator or learned by the action analyzer 30 may be referenced. The action analyzer 30 may provide the generated action history data to the action history storage 40.

The action history storage 40 may store action history data generated by the action analyzer 30. In some exemplary embodiments, the action history storage 40 may be a server for providing an RDB, for example, MySQL, MSSQL, MariaDB, etc. In some other embodiments, the action history storage 40 may be, for example, a NoSQL DB server. The action history storage 40 may provide the action history data to an administrator terminal and the like.

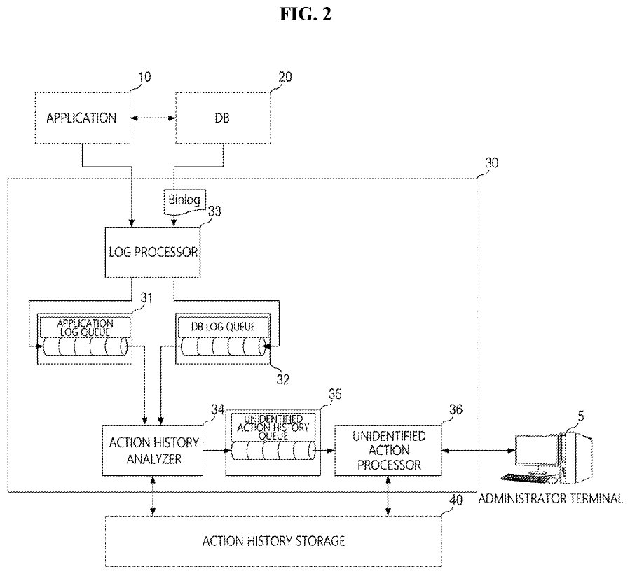

FIG. 2 is a diagram illustrating a configuration and operation of the action analyzer 30 of the server system 1 illustrated with reference to FIG. 1 in further detail.

Referring to FIG. 2, in some exemplary embodiments, the action analyzer 30 may include a log processor 33, an application log queue 31, a DB log queue 32, and an action history analyzer 34. In some other embodiments, the action analyzer 30 may additionally include an unidentified action history queue 35 and an unidentified action processor 36.

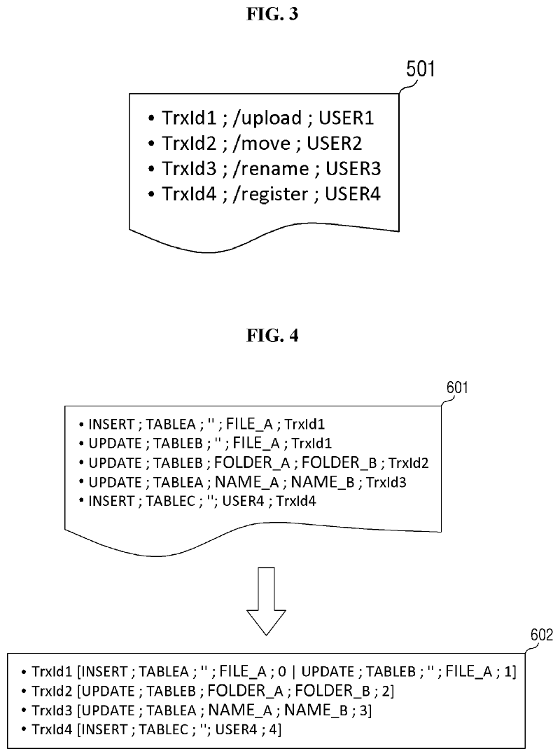

The log processor 33 may receive the application log from the application provider 10. In some exemplary embodiments, the application log may be a log file but is not limited thereto. The application log may be provided through various means, such as a memory and the like, which may be shared between the application provider 10 and the log processor 33. The log processor 33 may read the application log and insert the log entries into the application log queue 31. FIG. 3 is a diagram showing four log entries 501 recorded in an exemplary application log file. An application log entry may include a transaction ID, a called application program interface (API), ID information of a user who has requested a corresponding action, etc. The log processor 33 may distinguish log entries from each other, give a unique sequence number to each log entry, and insert the log entries into the application log queue 31.

In some other embodiments, the application log generated by the application provider 10 may be inserted into the application log queue 31 by the application provider 10 instead of being processed by the log processor 33.

The log processor 33 may receive the DB log from the DB provider 20. In some exemplary embodiments, the DB log may be a binary log or binlog file which is generally used for synchronization, dualization, and/or data recovery between DBs, but the present disclosure is not limited the embodiments. The log processor 33 may read the DB log and insert the log entries into the DB log queue 32. FIG. 4 is a diagram showing five log entries 601 recorded in an exemplary DB log file. The log processor 33 may distinguish log entries from each other, give a unique sequence number to each log entry, and insert the log entries into the DB log queue 32.

Referring back to FIG. 2, the action analyzer 30 may include the application log queue 31 and the DB log queue 32. The application log queue 31 and the DB log queue 32 temporarily store application log entries and DB log entries generated by the application provider 10 and the DB provider 20, respectively, and may provide the application log entries and DB log entries to the action history analyzer 34. Since the action analyzer 30 has temporary data storage spaces, such as the application log queue 31 and the DB log queue 32, it is unnecessary to wait until a subsequent log analysis process is finished as long as the application provider 10 and the DB provider 20 generate and output appropriate logs. Accordingly, it is possible to minimize a response delay which is caused by generating an action log for a user of an application service.

Meanwhile, the action analyzer 30 does not necessarily include a data storage having a queue structure, and it is to be noted that any appropriate data structure for temporarily storing application log entries and DB log entries may be used by the action analyzer 30.

Referring back to FIG. 2, the action analyzer 30 may include the action history analyzer 34. The action history analyzer 34 may extract log entries from each of the application log queue 31 and the DB log queue 32 and match the log entries to each other. At this time, the action history analyzer 34 may identify relational log entries using, for example, transaction IDs and match the relational log entries to each other.

In some exemplary embodiments, before matching application log entries to DB log entries, the action history analyzer 34 may group one or more DB log entries having the same transaction ID. Referring to FIG. 4, among the five log entries 601 recorded in an exemplary DB log file, the first and second entries having the same transaction ID, that is, “TrxId1,” may be grouped. An example of DB log entries grouped on the basis of transaction IDs is indicated by a reference number 602 in FIG. 4.

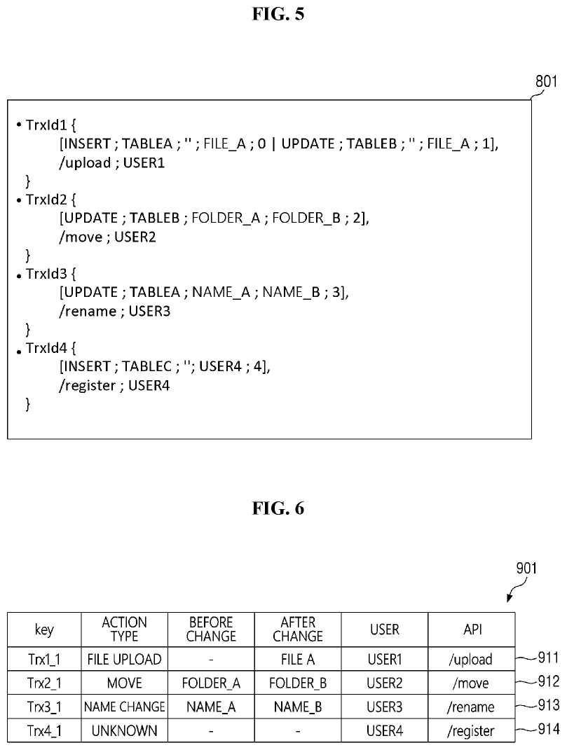

Also, the action history analyzer 34 may combine information of the application log entries and the DB log entries matched to each other. FIG. 5 shows an example in which the exemplary application log entries shown in FIG. 3 and the exemplary DB log entries shown in FIG. 4 are combined on the basis of transaction IDs. As described above, information of log entries recorded by the application and information of log entries recorded by the DB in the process of performing an action according to a user's request may be combined into one piece of information on the basis of transaction IDs and may be analyzed and processed as one piece of combined information in a subsequent process.

The action history analyzer 34 may analyze the information combined on the basis of transaction IDs and automatically determine the type of each action. In some exemplary embodiments, the action history analyzer 34 may determine a type of action with reference to action patterns registered in advance by the administrator. In some other exemplary embodiments, the action history analyzer 34 may determine a type of action using an artificial neural network model which is trained in advance.

The action history analyzer 34 may generate action history data including the information combined on the basis of transaction IDs and information on the action type.

FIG. 6 shows exemplary action history data generated by the action history analyzer 34. Referring to FIG. 6, among combined information items shown in FIG. 5, an item having the transaction ID “TrxId1” may be determined to have the type of action “file upload” on the basis of details of the item, and action history data 911 reflecting the action type may be generated. Likewise, among the combined information items shown in FIG. 5, an item having the transaction ID “TrxId3” may be determined to have the type of action “name change” on the basis of details of the item, and action history data 913 reflecting the action type may be generated.

Meanwhile, action history data for which the action history analyzer 34 fails to determine an action type may be processed as unidentified action history data. Among the combined information items shown in FIG. 5, an item having the transaction ID “TrxId4” is an example for which the action history analyzer 34 fails to determine an action type, and as a result, an action type field of action history data 914 is shown as “UNKNOWN” in FIG. 6.

The action history analyzer 34 may provide the generated action history data to the action history storage 40.

Meanwhile, unidentified action history data for which the action history analyzer 34 fails to determine action types may be stored in the unidentified action history queue 35 and processed by the unidentified action processor 36 provided in the action analyzer 30.

The unidentified action processor 36 may provide information on the unidentified action history data to the administrator of the server system 1, receive information on the types of unidentified action history data from the administrator, and reprocess the unidentified action history data.

Specifically, in some exemplary embodiments, the unidentified action processor 36 may provide a notification to the administrator every time the number of pieces of unidentified action history data exceeds a threshold value.

Also, in some exemplary embodiments, the unidentified action processor 36 may group items similar to each other in the unidentified action history data and provide a report including the result of grouping to the administrator. Specifically, unidentified action history data of which at least one of user information, time information, and target DB table information is the same or similar may be grouped.

Further, in some exemplary embodiments, the unidentified action processor 36 may provide an interface that enables the administrator to inquire about unidentified action history data and specify the types of unidentified action history data directly. When the action types of unidentified action history data are specified by the administrator, the unidentified action processor 36 may reprocess the unidentified action history data to generate action history data again and may provide the data whose action types are identified to the action history storage 40.

The server system 1 for providing a WAS according to an exemplary embodiment of the present disclosure has been described above with reference to the configuration of the server system 1 shown in FIGS. 1 and 2 and the exemplary log entries and the processing results shown in FIGS. 3 to 6.

According to the present embodiment, a log generated by an application and a log generated by a DB may be combined into one piece of information on the basis of transaction IDs and analyzed. Accordingly, in response to a user's request, it is possible to accurately analyze the action history of an application in detail, which can never be obtained by analyzing an application log or a DB log alone.

Also, according to the present embodiment, as long as an application and DB generate and provide appropriate logs to queues every time an action is triggered by a user's request, a subsequent log analysis process can be fully performed by the separate action analyzer 30, and thus the application does not have to wait for log processing and analysis to be completed. Accordingly, it is possible to minimize a response delay which is caused by generating and analyzing an action log for a user of an application service.

Further, according to the present embodiment, information on unidentified action history data whose action types are not determined may be arranged and provided to the administrator of the server system 1, and information on the types of unidentified action history data may be input by the administrator such that the unidentified action history data may be reprocessed. Accordingly, action patterns that are not considered in advance by the administrator or not learned by an artificial neural network model can be processed thereafter. In other words, it is possible to analyze requests from various users and actions of various applications caused by the requests.

A method of generating action history data of an application according to another exemplary embodiment of the present disclosure will be described below with reference to FIGS. 7 to 10 and 3 to 6 together.

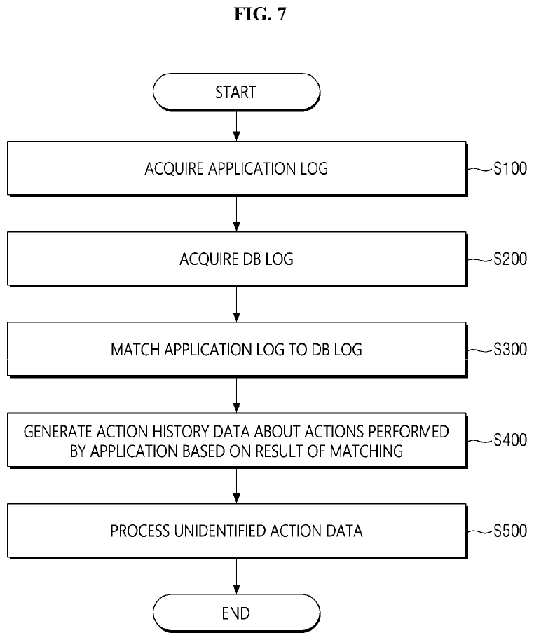

FIG. 7 is a flowchart illustrating a method of generating action history data of an application according to the present embodiment. The exemplary embodiment illustrated in FIG. 7 is merely an embodiment for achieving the purposes of embodiments of the present disclosure, and some operations may be added or removed as necessary. Each operation of the method of generating action history data of an application illustrated in FIG. 7 may be performed by, for example, the action analyzer 30. Each operation of the method of generating action history data of an application may be implemented as one or more instructions that are executed by a processor of a computing device. Although all operations included in the method of generating action history data of an application may be performed by one physical computing device, first operations of the method may be performed by a first computing device, and second operations of the method may be performed by a second computing device. The following description is based on the assumption that each operation of the method of generating action history data of an application is performed by the action analyzer 30. However, for convenience of description, a subject that performs each operation included in the method of generating action history data of an application may not be indicated.

Although not specifically mentioned, each operation of the method of generating action history data of an application according to the present embodiment may reflect the technical spirit of the exemplary embodiments described above with reference to FIGS. 1 and 2. Also, the technical spirit reflected in each operation of the method of generating action history data of an application according to the present embodiment may be reflected in the configuration and operations of the server system 1 described above with reference to FIGS. 1 and 2.

Referring to FIG. 7, the method of generating action history data of an application according to the present embodiment may include an operation S100 of acquiring an application log, an operation S200 of acquiring a DB log, an operation S300 of matching the application log to the DB log, and an operation S400 of generating action history data about an action performed by an application on the basis of the result of matching. In some exemplary embodiments, the method of generating action history data of an application may additionally include an operation S500 of processing unidentified action history data. Each operation will be described in further detail below.

First, in operation S100, an application log may be acquired. The application log may be generated by an application in the process of performing an action based on a user request or an action unrelated to any user request. The application log may include information on parameters that are involved in a request from a user and specify details of various requested actions. The application log may include IDs of DB transactions executed in the process of performing actions.

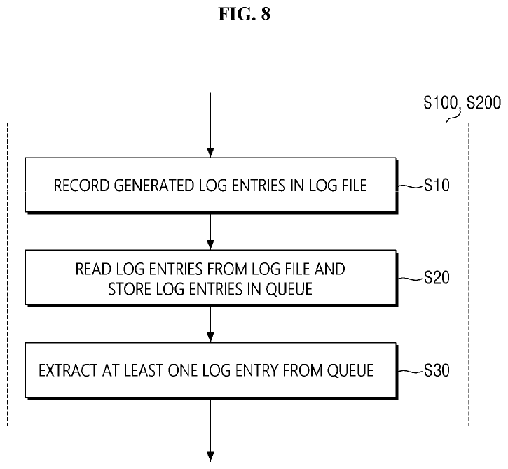

For deeper understanding of the detailed process of the operation S100, FIG. 8 may be referenced. Operations S10 to S30 of FIG. 8 may be performed by, for example, the log processor 33 described above with reference to FIG. 2.

According to some exemplary embodiments, in the operation S10, a log entry generated by the application may be recorded in an application log file.

In the operation S20, the application log entry may be read from the log file and stored in the application log queue 31. FIG. 3 is a diagram showing the four log entries 501 recorded in an exemplary application log file. An application log entry may include a transaction ID, a called API, ID information of a user who has requested a corresponding action, etc. Each log entry may be given a unique sequence number and inserted into the application log queue 31.

In the operation S30, at least one log entry may be extracted from the queue and become a target of a matching process in the operation S300 to be described below.

In some exemplary embodiments, the application log may be provided and acquired in the form of a log file, but the present disclosure is not limited thereto. Also, the application log may be directly inserted into the application log queue 31 by the application instead of being processed by the log processor 33.

Referring back to FIG. 7, the operation S200 will be described.

In the operation S200, a DB log may be acquired. The DB log may be generated as a result of a transaction executed on a DB by the application in the process of performing an action based on a user request or an action unrelated to any user request. In some exemplary embodiments, the DB log may be a binary log or binlog file which is generally used for synchronization, dualization, and/or data recovery between DBs, but the present disclosure is not limited the embodiments. The DB log may include information on data generation, update, deletion, etc. occurring on the DB in the process of performing an action and information on an ID of a transaction which causes the change.

FIG. 8 may also be referenced to understand a detailed process of the operation S200 of acquiring a DB log.

According to some exemplary embodiments, in the operation S10, DB log entries may be recorded in the log file.

In the operation S20, the DB log entries may be read from the log file and stored in the DB log queue 32. FIG. 4 shows the five log entries 601 recorded in an exemplary DB log file. Each log entry may be given a unique sequence number and inserted into the DB log queue 32.

In the operation S30, at least one log entry may be extracted from the queue and become a target of the matching process in the operation S300 to be described below. The above-described operations S10 to S30 may be performed by, for example, the log processor 33 described above with reference to FIG. 2.

Referring back to FIG. 7, operations S300 and S400 will be described.

In the operation S300, the application log entries and the DB log entries may be matched to each other on the basis of transaction IDs, and in the operation S400, action history data about actions performed by the application may be generated on the basis of the matching result of the operation S300.

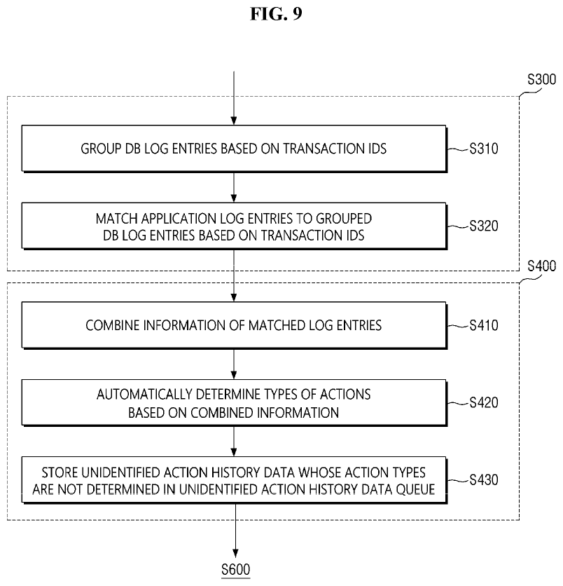

FIG. 9 is a flowchart illustrating the operations S300 and S400 in further detail.

Referring to FIG. 9, in an operation S310, DB log entries may be extracted from the DB log queue 32 and grouped. Specifically, one or more DB log entries having the same transaction ID may be grouped. Referring to FIG. 4, among the five log entries 601 recorded in an exemplary DB log file, the first and second entries having the same transaction ID, that is, “TrxId1,” may be grouped. An example of DB log entries grouped on the basis of transaction IDs is indicated by the reference number 602 in FIG. 4.

In an operation S320, application log entries may be extracted from the application log queue 31, DB log entries each related to the application log entries may be identified, and the application log entries and the DB log entries may be matched to each other. Here, the relationship between an application log entry and a DB log entry may be determined on the basis of transaction IDs, but the present disclosure is not limited to such an embodiment.

In an operation S410, information included in the matched log entries may be combined. FIG. 5 shows an example in which the exemplary application log entries shown in FIG. 3 and the exemplary DB log entries shown in FIG. 4 are combined on the basis of transaction IDs. As described above, information of log entries recorded by the application and information of log entries recorded by the DB in the process of performing an action according to a user's request may be combined into one piece of information on the basis of, for example, transaction IDs and may be analyzed and processed as one piece of combined information in a subsequent process.

In an operation S420, action types may be determined on the basis of the combined information. In some exemplary embodiments, action types may be determined with reference to action patterns registered in advance by an administrator. In some other embodiments, action types may be determined using an artificial neural network model which is trained in advance.

In an operation S420, action history data including the combined information and information on the determined action types may be generated.

FIG. 6 shows exemplary action history data that may be generated in the operation S420. Referring to FIG. 6, among the combined information items shown in FIG. 5, the item having the transaction ID “TrxId1” may be determined to have the type of action “file upload” on the basis of details of the item, and the action history data 911 reflecting the action type may be generated. Likewise, among the combined information items shown in FIG. 5, the item having the transaction ID “TrxId3” may be determined to have the type of action “name change” on the basis of details of the item, and the action history data 913 reflecting the action type may be generated.

The action history data generated in the operation S420 may be stored in the action history storage 40.

Meanwhile, in an operation S430, action history data whose action type is not determined in the operation S420 may be stored in an unidentified action history data queue. Among the combined information items shown in FIG. 5, the item having the transaction ID “TrxId4” is an example whose action type is not determined, and as a result, an action type field of action history data 914 is shown as “UNKNOWN” in FIG. 6.

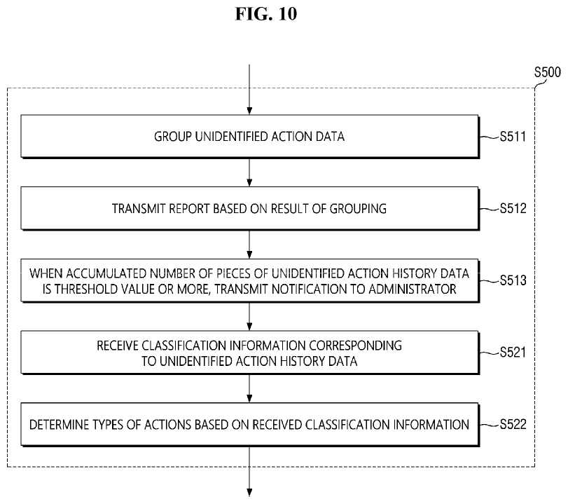

The operation S500 of processing unidentified action history data will be described in further detail below with reference to FIG. 10.

Referring to FIG. 10, in an operation S511, the unidentified action history data may be grouped. Specifically, items similar to each other in the unidentified action history data may be grouped. The similarity between pieces of unidentified action history data may be determined on the basis of at least one of, for example, user information, time information, and target DB table information corresponding to the unidentified action history data.

In an operation S512, a report including the result of grouping may be provided to the administrator. For example, at preset periods, a report in which the results of grouping pieces of unidentified action history data are arranged may be transmitted to the administrator.

In an operation S513, it may be determined whether the number of pieces of unidentified action history data exceeds a preset threshold value, and when the number of pieces of unidentified action history data exceeds the preset threshold value, a notification may be transmitted to the administrator. In some exemplary embodiments, every time the number of pieces of unidentified action history data exceeds the preset threshold value, a notification may be transmitted to the administrator.

In an operation S521, a list of unidentified action history data may be provided to the administrator through a user interface provided to the administrator, and classification information of at least some of the unidentified action history data may be received from an administrator terminal.

In an operation S522, when classification information of unidentified action history data is input by the administrator, accumulated unidentified action history data may be reprocessed, and action history data whose action types are identified may be generated.

As described above, in the operation S500, information on unidentified action history data may be provided to the administrator, and classification information of the unidentified action history data may be input by the administrator such that the unidentified action history data can be classified again and processed.

A server system for providing an application action history data service according to an exemplary embodiment of the present disclosure has been described above with reference to the flowcharts shown in FIGS. 7 to 10 and the exemplary log entries and the processing results shown in FIGS. 3 to 6.

According to the present embodiment, a log generated by an application and a log generated by a DB can be combined into one piece of information on the basis of transaction IDs and can be analyzed. Accordingly, in response to a user's request, it is possible to accurately analyze the action history of an application in detail, which can never be obtained by analyzing an application log or a DB log alone.

Also, according to the present embodiment, as long as an application and DB generate and provide appropriate logs to queues every time an action is triggered by a user's request, a subsequent log analysis can be fully performed by another component, and thus the application does not have to wait for log processing and analysis to be completed. Accordingly, it is possible to minimize a response delay which is caused by generating and analyzing an action log for a user of an application service.

Further, according to the present embodiment, information on unidentified action history data whose action types are not determined may be provided to an administrator, and information on the types of unidentified action history data may be input by the administrator such that the unidentified action history data can be reprocessed. Accordingly, data having action patterns that are not considered in advance by the administrator or not learned by an artificial neural network model can be processed thereafter. In other words, it is possible to analyze requests from various users and actions of various applications caused by the requests.

A method and device for generating action history data of an application according to some exemplary embodiments of the present disclosure have been described above with reference to FIGS. 1 to 10.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

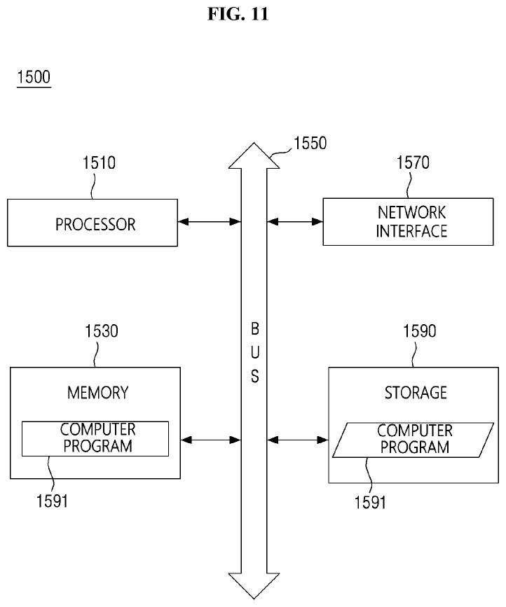

A hardware configuration of an exemplary computing device according to some exemplary embodiments of the present disclosure will be described below with reference to FIG. 11. The computing device to be described with reference to FIG. 11 may be a hardware configuration of the server system 1 described above with reference to FIGS. 1 and 2, the action analyzer 30 constituting the server system 1, etc.

FIG. 11 is a hardware configuration diagram of an exemplary computing device 500.

Referring to FIG. 11, the computing device 1500 may include one or more processors 1510, a bus 1550, a network interface 1570, a memory 1530, which loads a computer program 1591 executed by the processors 1100, and a storage 1590 for storing the computer program 1591.

The processor 1510 controls overall operations of each component of computing device 1500. The processor 1510 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 1510 may perform calculations on at least one application or program for executing a method/operation according to various embodiments of the present disclosure. The computing device 1500 may have one or more processors.

The memory 1530 stores various data, instructions and/or information. The memory 1530 may load one or more programs 1591 from the storage 1590 to execute methods/operations according to various embodiments of the present disclosure. An example of the memory 1530 may be a RAM, but is not limited thereto.

The bus 1550 provides communication between components of computing device 1000. The bus 1550 may be implemented as various types of bus such as an address bus, a data bus and a control bus.

The network interface 1570 supports wired and wireless internet communication of the computing device 1500. The network interface 1570 may support various communication methods other than internet communication. To this end, the network interface 1570 may be configured to include a communication module well known in the art of the present disclosure.

The storage 1590 can non-temporarily store one or more computer programs 1591. The storage 1590 may be configured to include a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 1591 may include one or more instructions, on which the methods/operations according to various embodiments of the present disclosure are implemented. When the computer program 1591 is loaded on the memory 1530, the processor 1510 may perform the methods/operations in accordance with various embodiments of the present disclosure by executing the one or more instructions.

Although the operations are shown in a specific order in the drawings, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation. The scope of protection of the present invention should be interpreted by the following claims, and all technical ideas within the scope equivalent thereto should be construed as being included in the scope of the technical idea defined by the present disclosure.

What is claimed is:

1. A method of generating action history data of an application, the method performed by a computing device, the method comprising:
acquiring a first log having application log entries generated by an application;
acquiring a second log having a database (DB) log entries generated by a database (DB);
matching the application log entries included in the first log to the DB log entries included in the second log; and
generating action history data about actions performed by the application on the basis of a result of the matching.

2. The method of claim 1, wherein the acquiring of the first log comprises:
storing the application log entries including information of the actions performed by the application in a first queue; and
extracting at least one log entry from the first queue.

3. The method of claim 2, wherein the application log entries include information of a user who has requested the actions performed by the application.

4. The method of claim 2, wherein the application log entries include transaction identifiers (IDs) of transactions committed on the DB by the actions performed by the application.

5. The method of claim 1, wherein the acquiring of the second log comprises:
recording, in a DB log file, the DB log entries including information on changes made in the DB by the actions performed by the application;
storing the DB log entries included in the DB log file in a second queue; and
extracting at least one log entry from the second queue.

6. The method of claim 1, wherein each of the application log entries and the DB log entries includes a transaction identifier (ID) field; and
the matching of the application log entries to the DB log entries comprises identifying an application log entry and a DB log entry having the same value in the transaction ID fields.

7. The method of claim 6, wherein the matching of the application log entries to the DB log entries further comprises grouping log entries having the same transaction ID among the DB log entries included in the second log.

8. The method of claim 1, wherein the generating of the action history data comprises combining information included in the matched log entries.

9. The method of claim 8, wherein the generating of the action history data further comprises storing the action history data in the DB.

10. The method of claim 8, wherein the generating of the action history data further comprises automatically determining types of the actions on the basis of the combined information.

11. The method of claim 10, wherein the generating of the action history data further comprises storing unidentified action history data whose action types are not determined in a third queue.

12. The method of claim 1, further comprising processing unidentified action history data.

13. The method of claim 12, wherein the processing of the unidentified action history data comprises:
determining the number of the pieces of unidentified action history data; and
generating a notification on the basis of a determination that the number is a threshold value or more.

14. The method of claim 12, wherein the processing of the unidentified action history data comprises:
grouping the pieces of unidentified action history data; and
providing a report including a result of the grouping.

15. The method of claim 14, wherein the grouping of the pieces of unidentified action history data comprises grouping the pieces of unidentified action history data on the basis of at least one of user information, time information, and target DB table information corresponding to the unidentified action history data.

16. The method of claim 12, wherein the processing of the unidentified action history data comprises receiving classification information corresponding to the unidentified action history data; and
the generating of the action history data comprises determining types of the actions and generating the action history data on the basis of the received classification information.

17. A computing device for generating action history data of an application, the computing device comprising:
a log processor configured to process a first log having application log entries generated by an application and a second log having a database (DB) log entries generated by a database (DB); and
an action history analyzer configured to match the application log entries included in the first log to the DB log entries included in the second log and generate action history data about actions executed by the application on the basis of a result of the matching.

18. The computing device of claim 17, wherein each of the application log entries and the DB log entries includes a transaction identifier (ID) field; and
the action history analyzer identifies an application log entry and a DB log entry having the same value in the transaction ID fields.

19. The computing device of claim 17, wherein the action history analyzer combines information included in the matched log entries.

20. A computer-readable non-transitory recording medium including instructions, wherein, when the instructions are executed by a processor, the instructions cause the processor to perform operations of:
acquiring a first log generated by an application;
acquiring a second log generated by a database (DB);
matching application log entries included in the first log to DB log entries included in the second log; and
generating action history data about actions performed by the application on the basis of a result of the matching.
